(19) United States
(12) Patent Application Publication
(10) Pub. No.: US 2009/0110967 A1
(43) Pub. Date: Apr. 30, 2009

(54) ELECTROLYTE MEMBRANE FOR POLYMER ELECTROLYTE FUEL CELL, PROCESS FOR ITS PRODUCTION, MEMBRANE/ELECTRODE ASSEMBLY FOR POLYMER ELECTROLYTE FUEL CELL AND METHOD OF OPERATING POLYMER ELECTROLYTE FUEL CELL

(75) Inventors: Satoru Hommura, Chiyoda-ku (JP); Atsushi Watakabe, Chiyoda-ku (JP); Jyunichi Tayanagi, Chiyoda-ku (JP); Susumu Saito, Chiyoda-ku (JP); Tetsuji Shimohira, Chiyoda-ku (JP); Eiji Endoh, Chiyoda-ku (JP)

Correspondence Address: OBLON, SPIVAK, MCCLELLAND MAIER & NEUSTADT, P.C., 1940 DUKE STREET, ALEXANDRIA, VA, 22314, US

(73) Assignee: ASAHI GLASS COMPANY LIMITED, Tokyo (JP)

(21) Appl. No.: 11/931,934

(22) Filed: Oct. 31, 2007

(51) Int. Cl. H01M 8/10

(52) U.S. Cl. 429/13; 429/33

(57) ABSTRACT

An electrolyte membrane for a polymer electrolyte fuel cell, which comprises an ion exchange membrane made of a fluoropolymer having a softening temperature of at least 90° C. and having acidic groups, and contains cerium atoms.

### BACKGROUND OF THE INVENTION

1. Field of the Invention

The present invention relates to an electrolyte membrane for a polymer electrolyte fuel cell, whereby operation at high temperature is possible, the initial output voltage is high, and the high output voltage can be obtained over a long period of time.

2. Discussion of Background

A fuel cell is a cell whereby a reaction energy of a gas as a feed material is converted directly to electric energy, and a hydrogen-oxygen fuel cell presents no substantial effect to the global environment since its reaction product is only water in principle. Especially, a polymer electrolyte fuel cell employing a polymer membrane as an electrolyte, can operate at room temperature to provide a high power density, as a polymer electrolyte membrane having high ionic conductivity has been developed, and thus is expected to be a prospective power source for mobile vehicles such as electric cars or for small cogeneration systems, along with an increasing social demand for an energy or global environmental problem in recent years.

Heretofore, as an electrolyte membrane for a polymer electrolyte fuel cell, a copolymer comprising repeating units based on CF₂═CFOCF₂CF(CF₃)O(CF₂)₂SO₃H and repeating units based on tetrafluoroethylene and having sulfonic acid groups (hereinafter referred to as a sulfonic acid type copolymer A) has been used.

The sulfonic acid type copolymer A has a softening temperature in the vicinity of from 70 to 80° C., and accordingly the operation temperature of a fuel cell using the copolymer is usually 80° C. or below. However, in a case where hydrogen obtainable by reforming methanol, natural gas, gasoline or the like is used as a fuel gas of a fuel cell, if carbon monoxide is contained even in a trace amount, the electrode catalyst will be poisoned, and the output of the fuel cell tends to be low. Therefore, to prevent such phenomenon, it is required to increase the operation temperature. Further, it is desired to increase the operation temperature to downsize a cooling apparatus of a fuel cell also, and a membrane capable of operation preferably at 120° C. or higher is desired. However, the above conventional sulfonic acid type copolymer A has a low softening temperature and thereby cannot meet such a request.

Accordingly, the following copolymers having a high softening temperature have been developed, such as a copolymer comprising repeating units based on tetrafluoroethylene and repeating units based on CF₂═CFOCF₂CF₂SO₃H (Patent Document 1), a copolymer comprising repeating units based on tetrafluoroethylene and repeating units based on CF₂═CFCF₂OCF₂CF₂SO₃H (Patent Document 2), and a copolymer comprising repeating units based on a monomer which gives a polymer having repeating units containing an alicyclic structure in its main chain and repeating units based on CF₂═CFOCF₂CF(CF₃)O(CF₂)₂SO₃H (Patent Document 3). A fuel cell using such a copolymer as the electrolyte membrane can operate at a high temperature of at least 80° C.

On the other hand, in the reduction reaction of oxygen at the cathode of a polymer electrolyte fuel cell, the reaction proceeds via hydrogen peroxide (H₂O₂), and it is worried that the electrolyte membrane may be deteriorated by hydrogen peroxide or peroxide radicals to be formed in the catalyst layer. Further, to the anode, oxygen molecules will come from the cathode through the membrane, and it is worried that hydrogen peroxide or peroxide radicals may be formed at the anode too. Especially when a hydrocarbon membrane is used as the polymer electrolyte membrane, it is poor in the stability against radicals, which used to be a serious problem in an operation for a long period of time.

It has been reported that even with a fuel cell employing an ion exchange membrane made of the sulfonic acid type copolymer A which is a perfluorocarbon polymer, the stability is very high in operation under high humidification, but the voltage decrease is significant in operation under low or no humidification conditions (Non-Patent Document 1). Namely, it is considered that, also in the case of the ion exchange membrane made of a perfluorocarbon polymer having sulfonic acid groups, deterioration of the electrolyte membrane proceeds due to hydrogen peroxide or peroxide radicals in operation under low or no humidification.

Patent Document 1: JP-A-63-297406

Patent Document 2: JP-A-2002-231268

Patent Document 3: JP-A-2002-260705

Non-Patent Document 1: Summary of debrief session for polymer electrolyte fuel cells research and development achievement in 2000 sponsored by New Energy and Industrial Technology Development Organization, page 56, lines 16 to 24

### SUMMARY OF THE INVENTION

Under these circumstances, for the practical application of a polymer electrolyte fuel cell to e.g. vehicles or housing markets, it is an object of the present invention to provide a membrane for a polymer electrolyte fuel cell, whereby power generation with sufficiently high energy efficiency is possible even at high operation temperature, high power generation property is achieved, and stable power generation is possible over a long period of time, either in its operation under low or no humidification where the humidification temperature (dew point) of the feed gas is lower than the cell temperature or in its operation under high humidification where humidification is carried out at a temperature close to the cell temperature.

The present inventors have conducted extensive studies on fuel cells employing an ion exchange membrane made of a fluoropolymer having acidic groups, which can be used at high operation temperature, for the purpose of preventing deterioration of the membrane in operation under low or no humidification, and as a result, they have found that deterioration of the electrolyte membrane can be remarkably suppressed by making the membrane made of a polymer having a high softening temperature contain cerium ions, and accomplished the invention.

The present invention provides an electrolyte membrane for a polymer electrolyte fuel cell, which comprises an ion exchange membrane made of a fluoropolymer having a softening temperature of at least 90° C. and having acidic groups, and contains cerium atoms.

The cerium ions are contained preferably as cerium ions. Otherwise, they are contained preferably as cerium oxide.

The present invention further provides a process for producing the above electrolyte membrane, which comprises mixing a dispersion liquid of a fluoropolymer having acidic groups with a cerium compounds soluble in the dispersion liquid, followed by cast membrane forming using the obtained liquid to prepare an electrolyte membrane.

The present invention further provides a membrane/electrode assembly for a polymer electrolyte fuel cell comprising an anode and a cathode each having a catalyst layer containing a catalyst, and an electrolyte membrane disposed between the anode and the cathode, wherein the electrolyte membrane is the above electrolyte membrane.

The present invention still further provides a method of operating a polymer electrolyte fuel cell provided with the above membrane/electrode assembly, which comprises power generation by supplying a hydrogen gas to the anode side and oxygen or an air to the cathode side at a temperature of at least 90° C.

Since the electrolyte membrane of the present invention has a high softening temperature and excellent resistance to hydrogen peroxide and peroxide radicals, a polymer electrolyte fuel cell provided with a membrane/electrode assembly having the electrolyte membrane of the present invention can operate at high temperature, is excellent in durability and is capable of power generation stably over a long period of time.

### DETAILED DISCUSSION OF THE PREFERRED EMBODIMENTS

The electrolyte membrane of the present invention is an ion exchange membrane made of a fluoropolymer having a softening temperature of at least 90° C. and having acidic groups. In this specification, the softening temperature is defined as a temperature at which the loss elastic modulus is maximum in dynamic viscoelasticity measurement at a heating rate of 2° C./min at a frequency of 1 Hz in a temperature region in which the polymer is softened and the storage modulus rapidly decreases.

In order to improve durability of the electrolyte membrane, it is necessarily made of a fluoropolymer, and particularly as a structure other than the acidic groups, a perfluorocarbon (which may contain an etheric oxygen atom) is preferred.

The acidic groups in the fluoropolymer are not particularly limited so long as they are dissociated to form protons, but they are preferably strongly acidic groups. Specifically, they may, for example, be sulfonic acid group, sulfonimide groups, phosphonic acid groups, carboxylic acid groups or ketoimide groups, and sulfonic acid groups which are highly acidic and highly chemically stable are particularly preferred.

As the perfluorocarbon polymer having sulfonic acid groups, the following copolymers (1) to (5) may, for example, be mentioned.

(1) A copolymer comprising repeating units based on tetrafluoroethylene and repeating units based on CF₂═CF(CF₂)ₐSO₃H (wherein “a” is an integer of from 0 to 6). Considering easiness of preparation, “a” is preferably 2 or 4.

(2) A copolymer comprising repeating units based on tetrafluoroethylene and repeating units based on CF₂═CFO(CF₂)_{b}SO₃H (wherein b in an integer of from 1 to 6). The shorter the length of the side chain having a sulfonic acid group (the smaller the number of carbon atoms i.e. b), the higher the softening temperature of the copolymer. However, considering easiness of preparation, b is preferably 2.

(3) A copolymer comprising repeating units based on tetrafluoroethylene and repeating units based on CF₂═CFCF₂O(CF₂)_{c}SO₃H (wherein c is an integer of from 1 to 6). Considering easiness of preparation, c is preferably 2.

(4) A copolymer comprising repeating units based on tetrafluoroethylene and repeating units based on a monomer represented by the formula (1):

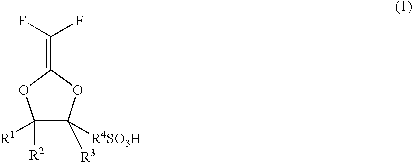

wherein each of R¹ to R³ which are independent of each other, is a C₁₆ perfluoroalkyl group which may contain an etheric oxygen atom, or a fluorine atom, and R⁴ is a C₁₋₆ perfluoroalkylene group which may contain an etheric oxygen atom.

The etheric oxygen atom in the perfluoroalkyl group which may contain an etheric oxygen atom or in the perfluoroalkylene group which may contain an etheric oxygen atom may be inserted between a bond of carbon atom-carbon atom or may be inserted at the terminal of the carbon atom bond. The monomer represented by the formula (1) is preferably a monomer represented by the formula (2) wherein R¹ to R³ are fluorine atoms and R⁴ is —CF₂OCF₂CF₂—, considering easiness of preparation:

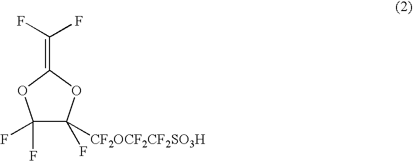

(5) A copolymer comprising repeating units based on tetrafluoroethylene, repeating units based on CF₂═CF(OCF₂CFX)_{d}O(CF₂)ₑSO₃H (wherein d is 0 or 1, X is a fluorine atom or a trifluoromethyl group, and e is an integer of from 1 to 5), and repeating units based on at least one member selected from the group consisting of a monomer represented by the formula (3) and a monomer represented by the formula (4):

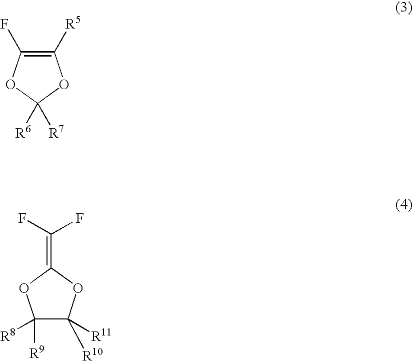

wherein R⁵ is a C₁₋₅ perfluoroalkyl group which may contain an etheric oxygen atom, or a fluorine atom, each of R⁶ and R⁷ which are independent of each other is a C₁₋₅ perfluoroalkyl group or a fluorine atom, or R⁶ and R⁷ together form a C₃₋₅ perfluoroalkylene group, and each of R⁸ to R¹¹ which are independent of one another, is a C₁₋₅ perfluoroalkyl group or a fluorine atom, or two among R⁸ to R¹¹ together form a C₃₋₅ perfluoroalkylene group.

The copolymer, which has repeating units based on at least one member selected from the group consisting of a monomer represented by the formula (3) and a monomer represented by the formula (4) as a third component, has a high softening temperature, and a monomer represented by the formula (5) is particularly preferred. The proportion of the repeating units based on at least one member selected from the group consisting of a monomer represented by the formula (3) and a monomer represented by the formula (4) to all the repeating units in the polymer is preferably from 0.1 to 50 mol %:

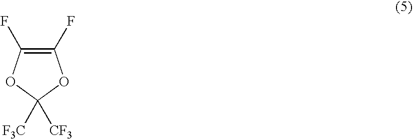

The perfluorocarbon polymer having sulfonic acid groups is obtained by copolymerizing a corresponding monomer having a fluorosulfonyl group (—SO₂F group), followed by hydrolysis and conversion to an acid form. In this specification, for example, a “copolymer comprising repeating units based on tetrafluoroethylene and repeating units based on CF₂═CF(CF₂)ₐSO₃H (wherein “a” is an integer of from 0 to 6)” means a copolymer obtained by copolymerizing tetrafluoroethylene with CF₂═CF(CF₂)ₐSO₂F, followed by hydrolysis and conversion to an acid form, and the same applies to other copolymers.

A perfluorocarbon polymer having sulfonimide groups (—SO₂NHSO₂R^{f} groups) is obtained by copolymerizing a monomer having a fluorosulfonyl group (—SO₂F group) of a corresponding monomer having a —SO₂F group converted to a sulfonimide group, or by preparing a corresponding polymer having —SO₂F groups and converting the —SO₂F groups of the polymer. The —SO₂F group is converted to a salt form sulfonimide group (—SO₂NMSO₂R^{f} group, wherein R^{f} is a perfluoroalkyl group, and M is an alkali metal or primary to quaternary ammonium) by the reaction with R^{f}SO₂NHM, and further converted to an acid form by treatment with an acid such as sulfuric acid, nitric acid or hydrochloric acid.

As a perfluorocarbon polymer having phosphonic acid groups, preferred is a copolymer comprising repeating units based on tetrafluoroethylene and repeating units based on CF₂═CFO(CF₂)₃PO(OH)₂.

The ion exchange capacity of the fluoropolymer having acidic groups is preferably from 0.7 to 2.5 meq/g dry resin, particularly preferably from 1.0 to 2.0 meq/g dry resin. If the ion exchange capacity is less than 0.7 meq/g dry resin, the ionic conductivity of the fluoropolymer tends to be insufficient. On the other hand, if the ion exchange capacity exceeds 2.5 meq/g dry resin, the water content tends to be too high, whereby when a membrane is formed using such a fluoropolymer, the membrane strength tends to be insufficient. Particularly when cerium ions or manganese ions are present in the electrolyte membrane as described hereinafter, they tend to ion-exchange the acid groups of the ion exchange membrane thereby to decrease the proton conductivity, and accordingly the ion exchange capacity of the fluoropolymer is preferably from 1.2 to 2.0 meq/g dry resin.

In a case where a perfluorocarbon polymer having sulfonic acid groups is used, it may be treated with a fluorine gas to stabilize unstable moieties at the polymer terminals. When the terminals of the polymer are fluorinated, the polymer will be more excellent in stability against hydrogen peroxide and peroxide radicals and thereby have improved durability. In the fluorination reaction, the fluorine gas is preferably a fluorine gas diluted with an inert gas.

The electrolyte membrane of the present invention, in which cerium atoms are present, is excellent in durability. The state of presence of cerium atoms in the membrane is not particularly limited, and the cerium atoms are present, for example, as cerium ions or a cerium compound, preferably cerium ions. The state of a metal simple substance or an alloy is unfavorable, which may cause short-circuiting of the electrolyte membrane.

For example, in the case of cerium ions, they may be present in the electrolyte membrane in any state so long as they are present as ions, and a state where part of the acidic groups in the ion exchange membrane are ion-exchanged with cerium ions may be mentioned. Further, the electrolyte membrane does not necessarily contain cerium ions uniformly. The electrolyte membrane may be an ion exchange membrane (laminated membrane) comprising two or more layers, and not all the layers but at least one layer is ion-exchanged with cerium ions, that is, the electrolyte membrane may contain cerium ions nonuniformly in the thickness direction. Accordingly, when it is required to increase durability against hydrogen peroxide or peroxide radicals particularly at the anode side, only the layer closest to the anode may be a layer comprising an ion exchange membrane containing cerium ions.

The process for obtaining the electrolyte membrane of the present invention by incorporating cerium ions to the fluoropolymer having acidic groups is not particularly limited, and the following processes may, for example, be mentioned.

(1) A process of mixing a dispersion liquid of a fluoropolymer having acidic groups with a cerium compound soluble in the dispersion liquid, followed by cast membrane forming using the obtained liquid to prepare an electrolyte membrane.

(2) A process of immersing a membrane made of a fluoropolymer having acidic groups in a solution containing cerium ions.

(3) A process of bringing an organic metal complex of cerium into contact with an ion exchange membrane made of a fluoropolymer having acidic groups to incorporate cerium ions to the ion exchange membrane.

Considering mass productivity, the process (1) is carried out most easily and is preferred.

It is considered that in the electrolyte membrane obtained by the above process, part of the acidic groups are ion-exchanged with cerium ions.

The cerium ions may be either trivalent or tetravalent, and a cerium compound soluble in a liquid medium (such as water or an alcohol) is used so as to obtain a solution containing cerium ions. Specific examples of a salt containing a trivalent cerium ion include cerium(III) carbonate (Ce₂(CO₃)₃.8H₂O), cerium(III) acetate (Ce(CH₃COO)₃.H₂O), cerium(III) chloride (CeCl₃.6H₂O), cerium(III) nitrate (Ce(NO₃)₃.6H₂O) and cerium(III) sulfate (Ce₂(SO₄)₃.8H₂O). Specific examples of a salt containing a tetravalent cerium ion include cerium(IV) sulfate (Ce(SO₄)₂.4H₂O), cerium(IV) diammonium nitrate (Ce(NH₄)₂(NO₃)₆) and cerium(IV) tetraammonium sulfate (Ce(NH₄)₄(SO₄)₄.4H₂O). In addition, examples of an organic metal complex salt of cerium include cerium(III) acetylacetonate (Ce(CH₃COCHCOCH₃)₃.3H₂O).

Among the above compounds, in a case where the electrolyte membrane is prepared by the above process (1), the cerium compound soluble in a dispersion liquid of a fluoropolymer is preferably cerium(III) carbonate. Cerium carbonate or the like is dissolved in the dispersion liquid of a fluoropolymer to form cerium ions and at the same time, carbonic acid can be removed as a gas. Further, in a case where the electrolyte membrane is prepared by the above process (2), preferred is use of an aqueous solution of cerium nitrate or cerium sulfate, in view of easy handling. Nitric acid or sulfuric acid formed when the fluoropolymer having acidic groups is ion-exchanged in such an aqueous solution, is easily dissolved in the aqueous solution and removed.

For example, in a case where cerium ions are trivalent and the acidic groups are sulfonic acid groups, when the sulfonic acid groups are ion-exchanged with cerium ions, Ce³⁺ is bonded to three —SO₃⁻, as shown below:

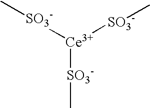

In a case where the acidic groups in the fluoropolymer are sulfonic acid groups, the amount of cerium ions contained in the electrolyte membrane is preferably from 0.3 to 20 mol % of —SO₃⁻ groups in the membrane (hereinafter this ratio will be referred as the “content of cerium ions”). In a case where a cerium ion completely has the above structure, the above content is the same as the content of sulfonic acid groups ion-exchanged with a cerium ion of from 0.9 to 60 mol % of the total amount of the sulfonic acid groups and the sulfonic acid groups ion-exchanged with a cerium ion. The content of cerium ions is more preferably from 0.7 to 16 mol %, furthermore preferably from 1 to 13 mol %.

If the content of cerium ions is lower than the above range, no adequate stability against hydrogen peroxide or peroxide radical may be secured. On the other hand, if the content of cerium ions is higher than the above range, no adequate conductivity of hydrogen ions may be secured, whereby the membrane resistance may increase to lower the power generation property.

The durability of the electrolyte membrane can be improved also by making the electrolyte membrane contain a cerium compound. In a case where the cerium compound is water soluble, it is considered to be present as ions in the membrane as described above, but even when the cerium compound is hardly soluble in water, the electrolyte membrane of the present invention has excellent resistance to hydrogen peroxide or peroxide radicals and is excellent in durability. The reason is not necessarily clear but is considered to be because of either of the following mechanisms. First, it is considered that the hardly soluble cerium compound is dissociated in the membrane or partially dissolved to form cerium ions, part of the acidic groups are ion-exchanged with cerium ions, and the ions effectively improve the resistance of the electrolyte membrane to hydrogen peroxide or peroxide radicals. Otherwise, it is considered that the cerium element in the hardly soluble cerium compound has a function to effectively decompose hydrogen peroxide diffused from the catalyst layer into the membrane.

Specifically, the hardly soluble cerium compound may, for example, be cerium(III) phosphate, cerium(IV) phosphate, cerium oxide, cerium(III) hydroxide, cerium(IV) hydroxide, cerium fluoride, cerium oxalate, cerium tungstate, or a cerium salt of a heteropolyacid, and cerium oxide is particularly preferred, which has a high effect of decomposing hydrogen peroxide.

The process of incorporating the hardly soluble cerium compound to the fluoropolymer having acidic groups to obtain the electrolyte membrane of the present invention is not particularly limited, and the following processes may, for example, be mentioned.

(1) A process of adding a hardly soluble cerium compound to a dispersion liquid of a fluoropolymer having acidic groups so that the dispersion liquid contains the hardly soluble cerium compound, followed by membrane forming by e.g. casting using the obtained liquid. The hardly soluble cerium compound may be preliminarily mixed with a solvent (dispersion medium) in which the compound can be highly dispersed, and then the mixture is mixed with a solution or a dispersion liquid of the fluoropolymer having acidic groups.

(2) A process of immersing a membrane made of a fluoropolymer having acidic groups in a solution containing cerium ions to incorporate the ions to the membrane, and then immersing the membrane in a solution containing a substance which reacts with cerium ions to form a hardly soluble cerium compound or the like, such as phosphoric acid, oxalic acid, NaF or sodium hydroxide, to precipitate the hardly soluble cerium compound or the like in the membrane.

(3) A process of adding, to a dispersion liquid of a fluoropolymer having acidic groups, a cerium compound soluble in the dispersion liquid, to ion-exchange the acidic groups with cerium ions, and adding a substance which reacts with cerium ions to form a hardly soluble cerium compound such as phosphoric acid, oxalic acid, NaF or sodium hydroxide or a solution containing such a substance, to the dispersion liquid to form the hardly soluble cerium compound in the dispersion liquid, followed by membrane forming by e.g. casting using the obtained liquid. The cerium compound soluble in the dispersion liquid of the fluoropolymer may, for example, be cerium acetate, cerium chloride, cerium nitrate or cerium sulfate.

(4) A process of adding a hardly soluble cerium compound to a precursor of a fluoropolymer having acidic groups, followed by kneading by twin screw extrusion, pelletizing, formation into a film by single screw extrusion, and membrane forming by hydrolysis and conversion to an acid form. The precursor of the fluoropolymer is a polymer having functional groups capable of being converted to acidic groups which function as ion exchange groups, and in a case where the acidic groups are sulfonic acid groups, it is a polymer having —SO₂F groups.

Among the above processes, particularly the process (2) is preferred, by which the amount of substitution by cerium ions or the like can be controlled, it is possible to adjust the thickness of the membrane at the time of membrane forming, and a membrane having a uniform thickness is likely to be obtained.

In the present invention, the proportion of the hardly soluble cerium compound such as cerium oxide contained in the electrolyte membrane is preferably from 0.3 to 80% (mass ratio) of the entire mass of the electrolyte membrane, more preferably from 0.4 to 70%, furthermore preferably from 0.5 to 50%. If the content of the hardly soluble cerium compound or the like in the membrane is lower than this range, no sufficient stability against hydrogen peroxide or peroxide radicals may be secured. Further, if the content is higher than this range, electric current shielding may occur, whereby the membrane resistance may increase to lower the power generation property.

The polymer electrolyte fuel cell provided with the electrolyte membrane of the present invention has, for example, the following structure. Namely, the cell is provided with a membrane/electrode assembly which comprises an anode and a cathode each having a catalyst layer containing a catalyst and an ion exchange resin, disposed on both sides of the electrolyte membrane of the present invention. The anode and the cathode of the membrane/electrode assembly preferably have a gas diffusion layer made of carbon cloth, carbon paper, or the like disposed outside the catalyst layer (opposite to the membrane). Separators having grooves formed to constitute flow paths for a fuel gas or an oxidizing agent gas are disposed on both sides of the membrane/electrode assembly. A plurality of such membrane/electrode assemblies is stacked with the separators to form a stack, and a hydrogen gas is supplied to the anode side and an oxygen gas or air to the cathode side. A reaction of H₂→2H⁺+2e⁻ takes place on the anode, and a reaction of 1/2O₂+2H⁺+2e⁻→H₂O on the cathode, whereby chemical energy is converted into electric energy.

Furthermore, the electrolyte membrane of the present invention is also applicable to direct methanol fuel cells in which methanol is supplied instead of the fuel gas to the anode side.

The above-mentioned catalyst layer may be obtained in accordance with conventional methods, for example, as follows. First, a conductive carbon black powder carrying particles of a platinum catalyst or a platinum alloy catalyst, is mixed with a solution of a fluoropolymer having acidic groups to obtain a uniform dispersion liquid, and gas diffusion electrodes are formed, for example, by any one of the following methods, to obtain a membrane/electrode assembly.

The first method is a method of applying the above-mentioned dispersion liquid to both surfaces of the electrolyte membrane, drying it, and then attaching two sheets of carbon cloth or carbon paper closely onto the both sides. The second method is a method of applying the above-mentioned dispersion liquid to two sheets of carbon cloth or carbon paper, drying it, and then placing the two sheets on both sides of the above electrolyte membrane so that the surfaces coated with the dispersion liquid are close in contact with the electrolyte membrane. The carbon cloth or carbon paper herein functions as gas diffusion layers to more uniformly diffuse the gas to the catalyst-containing layers, and functions as current collectors. Furthermore, another available method is such that a substrate separately prepared is coated with the above-mentioned dispersion liquid to make a catalyst layer, such catalyst layers are bonded to an electrolyte membrane by a method such as transcription, then the substrate is peeled off, and the electrolyte membrane is sandwiched between the above-mentioned gas diffusion layers.

The fluoropolymer having acidic groups contained in the catalyst layer is not particularly limited, but is preferably a fluorocopolymer having a softening temperature of at least 90° C. and having acidic groups, just like the resin constituting the electrolyte membrane of the present invention. The catalyst layer may contain cerium atoms just like the electrolyte membrane of the present invention. Such a catalyst layer containing cerium atoms can be applied to both anode and cathode, and decomposition of the resin can be effectively suppressed, so as to further enhance the durability of the polymer electrolyte fuel cell.

The electrolyte membrane of the present invention may be a membrane made of only a fluorocopolymer having acidic groups, some of which are replaced by cerium atoms, but it may contain another component, or it may be a membrane reinforced by e.g. fibers, woven cloth, non-woven cloth or a porous material of another resin such as a polytetrafluoroethylene or a perfluoroalkyl ether.

The polymer electrolyte fuel cell provided with the membrane/electrode assembly of the present invention can operate at 90° C. or higher to generate the electric power. In a case where the fuel gas is hydrogen obtained by reforming methanol, natural gas, gasoline or the like, if carbon monoxide is contained even in a trace amount, the electrolyte catalyst will be poisoned, and the output of the fuel cell tends to be low. When the operation temperature is at least 90° C., it is possible to suppress the poisoning. The operation temperature is more preferably at least 120° C., whereby the effect of suppressing the poisoning tends to be high.

Now, the present invention will be described in further detail with reference to Examples (Examples 1 to 6) and Comparative Examples (Examples 7 to 12). However, it should be understood that the present invention is by no means restricted to such specific Examples.

### EXAMPLE 1

CF₂═CFCF₂CF₂SO₂F was prepared by the same method as disclosed in JP-A-2002-528433 (Example 1). To a stainless steel autoclave having an internal capacity of 100 mL, (CF₃)₃C—O—O—C(CF₃)₃ (5.6 mg) and CF₂═CFCF₂CF₂SO₂F (63.75 g) were charged, followed by sufficient deaeration under cooling with liquid nitrogen. Then, the temperature was increased to 100° C., tetrafluoroethylene was introduced to the system, and the pressure was maintained at 0.59 MPaG. A nitrogen gas was added to adjust the pressure at 1.05 MPaG. Then, the temperature was increased to 130° C. and the pressure was maintained at 1.3 MPaG. After stirring at 130° C. for 17 hours, the gas in the system was purged, and the autoclave was cooled to terminate the reaction.

The product was diluted with CClF₂CF₂CHClF, and CH₃CCl₂F was added to coagulate the polymer, which was subjected to filtration. Then, the polymer was stirred in CClF₂CF₂CHClF, re-coagulated by CH₃CCl₂F, and dried under reduced pressure at 80° C. overnight. The formation amount was 2.5 g.

To the obtained polymer, a fluorine gas diluted to 20% with a nitrogen gas was introduced to 0.3 MPaG, and the polymer was maintained at 180° C. for 4 hours. Then, a membrane having a thickness of about 50 μm was obtained by hot pressing. For hydrolysis, first, the membrane was immersed in a solution of KOH in water and dimethyl sulfoxide as solvents (KOH/water/dimethyl sulfoxide=15/55/30 mass ratio) and then immersed in hydrochloric acid for conversion to an acid form, and the membrane was washed with ultrapure water.

The ion exchange capacity of the obtained ion exchange membrane was measured by titration and as a result, it was 1.13 meq/g dry resin.

The softening temperature of the membrane was measured. Using a dynamic viscoelasticity analyzer DVA200 (manufactured by ITK Co., Ltd.), the dynamic viscoelasticity was measured under conditions with a sample width of 0.5 cm, a length of specimen between grips being 2 cm at a measuring frequency of 1 Hz at a temperature raising rate of 2° C./min. The softening temperature determined from the maximum loss elastic modulus was 130° C.

12.0 mg of cerium(III) nitrate Ce(NO₃)₃.6H₂O) is dissolved in 500 mL of distilled water so that cerium ions (trivalent) in an amount corresponding to 10% of the amount of sulfonic acid groups in the obtained membrane are contained, and 0.8 g of the ion exchange membrane is immersed in the solution, followed by stirring at room temperature for 40 hours using a stirrer to incorporate cerium ions to the ion exchange membrane. The cerium(III) nitrate solution before and after immersion is analyzed by ion chromatography to calculate the content of cerium ions in the ion exchange membrane (the proportion of cerium ions to the number of —SO₃⁻ groups in the membrane) and as a result, it is 10%.

A CF₂═CF₂/CF₂═CFOCF₂CF(CF₃)O(CF₂)₂SO₃H copolymer (ion exchange capacity: 1.2 meq/g dry resin) is dispersed in ethanol using a pressure resistant autoclave, the inner surface of which is made of a hastelloy C alloy, to obtain an ethanol dispersion liquid having a solid content of 10% by the mass ratio, which will be referred to as electrolyte liquid A. To 20 g of a catalyst having 50% by the mass ratio of platinum supported on a carbon black powder, 126 g of water is added, and ultrasonic waves are applied for 10 minutes to uniformly disperse the catalyst. To the dispersion liquid, 80 g of electrolyte liquid A is added, and 54 g of ethanol is further added to adjust the solid content concentration to 10%, and this dispersion liquid will be referred to as a coating liquid for forming a cathode catalyst layer. This coating liquid is applied to a sheet made of an ethylene/tetrafluoroethylene copolymer (tradename: AFLEX lOON, manufactured by Asahi Glass Company, Limited, hereinafter referred to simply as an ETFE sheet) and dried to prepare a cathode catalyst layer having a platinum amount of 0.5 mg/cm².

Further, to 20 g of a catalyst having 53% by the mass ratio of an alloy of platinum and ruthenium (platinum/ruthenium ratio=30/23) supported on a carbon black powder, 124 g of water is added, ultrasonic waves are applied for 10 minutes to uniformly disperse the catalyst, and 75 g of the above electrolyte liquid A is added and 56 g of ethanol is further added to adjust the solid content concentration to 10% (mass ratio), to prepare a coating liquid for forming an anode catalyst layer. The coating liquid is applied to an ETFE substrate film and dried to prepare an anode catalyst layer having a platinum amount of 0.35 mg/cm².

The electrolyte membrane is sandwiched between the cathode catalyst layer and the anode catalyst layer, followed by hot pressing (pressing conditions: 120° C., 2 minutes, 3 MPa) to bond the catalyst layers to the membrane, and each substrate film is separated to obtain a membrane/catalyst layer assembly having an electrode area of 25 cm².

The membrane/catalyst layer assembly is sandwiched between two gas diffusion layers each made of carbon paper to obtain a membrane/electrolyte assembly. Each carbon paper has a layer made of carbon and a polytetrafluoroethylene on one surface, and the carbon paper is disposed so that the above layer is in contact with the catalyst layer of the membrane/catalyst layer assembly. The membrane/electrode assembly is assembled into a cell for power generation, and hydrogen (utilization ratio: 50%) and air (utilization ratio: 50%) are supplied to the cell as gases humidified at a dew point of 100° C. under a pressure of 0.2 MPa. The cell voltage is recorded by fixing the cell temperature at 120° C. and the electric current density at 0.2 A/cm². The initial voltage and the time until the voltage decreases to 0.5 V are examined. The results are shown in Table 2. In Table 2, ⊚ indicates a time until the voltage decreases to 0.5 V being 2,000 hours or longer, ◯ indicates the time being 900 hours or longer but less than 2,000 hours, and X indicates the time being less than 900 hours.

### EXAMPLE 2

In the same manner as in the method disclosed in JP-A-63-297406 (Example 1), an ion exchange membrane made of a polymer comprising repeating units based on tetrafluoroethylene and repeating units based on CF₂═CFO(CF₂)₂SO₃H is formed, and the ion exchange capacity and the softening temperature are measured, whereupon results as shown in Table 1 are obtained. Further, an electrolyte membrane having cerium ions incorporated to the ion exchange membrane is obtained, and the content of the cerium ions is measured in the same manner as in Example 1, whereupon results as shown in Table 1 are obtained. Further, a membrane/electrode assembly is obtained in the same manner as in Example 1, and the cell voltage is examined, whereupon results as shown in Table 2 are obtained.

### EXAMPLE 3

In the same manner as in the method disclosed in United States Patent Application 20040121210, an ion exchange membrane made of a polymer comprising repeating units based on tetrafluoroethylene and repeating units based on CF₂═CFO(CF₂)₄SO₃H is formed, and the ion exchange capacity and the softening temperature are measured, whereupon results as shown in Table 1 are obtained. Further, an electrolyte membrane having cerium ions incorporated to the ion exchange membrane is obtained, and the content of the cerium ions is measured in the same manner as in Example 1, whereupon results as shown in Table 1 are obtained. Further, a membrane/electrode assembly is obtained in the same manner as in Example 1, and the cell voltage is examined, whereupon results as shown in Table 2 are obtained.

### EXAMPLE 4

In the same manner as in the method disclosed in JP-A-2002-231268 (Example 1), an ion exchange membrane made of a polymer comprising repeating units based on tetrafluoroethylene and repeating units based on CF₂═CFCF₂O(CF₂)₂SO₃H is formed, and the ion exchange capacity and the softening temperature are measured, whereupon results as shown in Table 1 are obtained. Further, an electrolyte membrane having cerium ions incorporated to the ion exchange membrane is obtained, and the content of the cerium ions is measured in the same manner as in Example 1, whereupon results as shown in Table 1 are obtained. Further, a membrane/electrode assembly is obtained in the same manner as in Example 1, and the cell voltage is examined, whereupon results as shown in Table 2 are obtained.

### EXAMPLE 5

In the same manner as in the method disclosed in WO2004/97851 (Example 7), an ion exchange membrane made of a polymer comprising repeating units based on tetrafluoroethylene and repeating units based on the following monomer (2) is formed, and the ion exchange capacity and the softening temperature are measured, whereupon results as shown in Table 1 are obtained. Further, an electrolyte membrane having cerium ions incorporated to the ion exchange membrane is obtained, and the content of the cerium ions is measured in the same manner as in Example 1, whereupon results as shown in Table 1 are obtained. Further, a membrane/electrode assembly is obtained in the same manner as in Example 1, and the cell voltage is examined, whereupon results as shown in Table 2 are obtained.

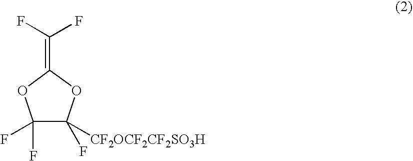

### EXAMPLE 6

In the same manner as in the method disclosed in JP-A-2002-260705 (Preparation Example 8), a polymer comprising repeating units based on tetrafluoroethylene, repeating units based on the following compound (5) and repeating units based on CF₂═CFOCF₂CF(CF₃)O(CF₂)₂SO₃H is prepared. The amount of the repeating units based on the following compound (5) is 42 mol %.

The obtained polymer is immersed in a solution of KOH in water and dimethyl sulfoxide as solvents (KOH/water/dimethyl sulfoxide=15/55/30 mass ratio) and then immersed in hydrochloric acid for conversion to an acid form, and then washed with ultrapure water. The polymer converted to an acid form is dispersed in a solvent mixture of ethanol and water (70/30 mass ratio) to obtain a dispersion liquid having a solid content of 9% by the mass ratio. To 100 g of the dispersion liquid, 0.29 g of cerium(III) carbonate hydrate (Ce₂(CO₃)₃.8H₂O) is added to obtain a dispersion liquid containing cerium ions. The dispersion liquid is applied to an ETFE sheet of 100 μm by a die coater to form a membrane, which is dried at 80° C. for 30 minutes and further annealed at 150° C. for 30 minutes to form an ion exchange membrane having a thickness of 50 μm. The ion exchange capacity and the softening temperature of the ion exchange membrane are measured, whereupon results as shown in Table 1 are obtained.

Further, an electrolyte membrane having cerium ions incorporated to the ion exchange membrane is obtained, and the content of cerium ions is measured in the same manner as in Example 1, whereupon results as shown in Table 1 are obtained. Further, a membrane/electrode assembly is obtained in the same manner as in Example 1, and the cell voltage is examined, whereupon results as shown in Table 2 are obtained.

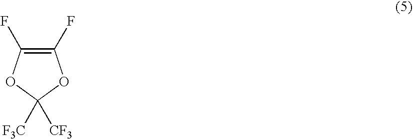

### EXAMPLES 7 TO 11

An electrolyte membrane is formed in the same manner as in each of Examples 2 to 6 except that no cerium ions are contained, and a membrane/electrode assembly is obtained. The cell voltage is examined, whereupon results as shown in Table 2 are obtained.

### EXAMPLE 12

An ion exchange membrane made of a polymer comprising repeating units based on tetrafluoroethylene and repeating units based on CF₂═CFOCF₂CF(CF₃)O(CF₂)₂SO₃H is formed, and the ion exchange capacity and the softening temperature are measured, whereupon results as shown in Table 1 are obtained. A membrane/electrode assembly is obtained in the same manner as in Example 1, and the cell voltage is examined, whereupon results as shown in Table 2 are obtained.

### EXAMPLE 13

(A) Preparation of Compound (m12)

Compound (m12) was prepared by the following synthetic root.

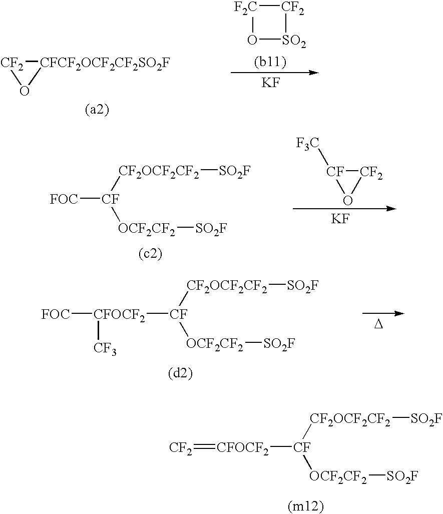

(i) Preparation of Compound (a2):

Compound (a2) was prepared in the same manner as in the method as disclosed in Example 2 of JP-A-57-176973.

(ii) Preparation of Compound (c2):

To a 300 cm³ four-necked round bottom flask equipped with a Dimroth condenser, a thermometer, a dropping funnel and a glass rod with an agitating blade, 1.6 g of potassium fluoride (tradename: Chloro-Catch F, manufactured by MORITA CHEMICAL INDUSTRIES CO., LTD.) and 15.9 g of dimethoxyethane were put in a nitrogen atmosphere. Then, the round bottom flask was cooled in an ice bath, and 49.1 g of compound (b11) was added dropwise from the dropping funnel over a period of 32 minutes at an internal temperature of at most 10° C. After completion of the dropwise addition, 82.0 g of compound (a2) was added dropwise from the dropping funnel over a period of 15 minutes. Substantially no increase in the internal temperature was observed. After completion of the dropwise addition, the internal temperature was recovered to room temperature, followed by stirring for about 90 minutes. The lower layer was recovered by a separatory funnel. The recovered amount was 127.6 g, and the gas chromatography (hereinafter referred to as GC) purity was 55%. The recovered liquid was put in a 200 cm³ four-necked round bottom flask, followed by distillation to obtain 97.7 g of compound (c2) as a fraction at a degree of vacuum of from 1.0 to 1.1 kPa (absolute pressure). The GC purity was 98%, and the yield was 80%.

(iii) Preparation of Compound (d2):

To a 200 cm³ autoclave made of stainless steel, 1.1 g of potassium fluoride (tradename: Chloro-Catch F, manufactured by MORITA CHEMICAL INDUSTRIES CO., LTD.) was put. After deaeration, 5.3 g of dimethoxyethane, 5.3 g of acetonitrile and 95.8 g of compound (c2) were put in the autoclave under reduced pressure.

Then, the autoclave was cooled in an ice bath, 27.2 g of hexafluoropropene oxide was added over a period of 27 minutes at an internal temperature of from 0 to 5° C., and the internal temperature was recovered to room temperature with stirring, followed by stirring overnight. The lower layer was recovered by a separatory funnel. The recovered amount was 121.9 g, and the GC purity was 63%. The recovered liquid was subjected to distillation to obtain 72.0 g of compound (d2) as a fraction at a boiling point of 80 to 84° C./0.67 to 0.80 kPa (absolute pressure). The GC purity was 98%, and the yield was 56%.

(iv) Preparation of Compound (m12):

Using a stainless steel tube with an inner diameter of 1.6 cm, a U-tube with a length of 40 cm was prepared. One end of the U-tube was filled with glass wool, and the other end was filled with glass beads with a stainless steel sintered metal as a perforated plate to prepare a fluidized bed type reactor. A nitrogen gas was used as a fluidizing gas so that raw materials could be continuously supplied by a metering pump. The outlet gas was collected using a trap tube with liquid nitrogen.

The fluidized bed type reactor was put in a salt bath, and 34.6 g of compound (d2) was supplied to the fluidized bed type reactor over a period of 1.5 hours so that the molar ratio of compound (d2)/N₂ would be 1/20 while the reaction temperature was maintained at 340° C. After completion of the reaction, 27 g of a liquid was obtained by the liquid nitrogen trap. The GC purity was 84%. The liquid was subjected to distillation to obtain compound (m12) as a fraction at a boiling point of 69° C./0.40 kPa (absolute pressure). The GC purity was 98%.

¹⁹F-NMR (282.7 MHz, solvent: CDCl₃, standard: CFCl₃) of compound (m12).

δ(ppm): 45.5(1F), 45.2(1F), −79.5(2F), −82.4(4F), −84.1(2F), −112.4(2F), −112.6(2F), −112.9 (dd, J=82.4 Hz, 67.1 Hz, 1F), −121.6 (dd, J=112.9 Hz, 82.4 Hz, 1F), −136.0 (ddt, J=112.9 Hz, 67.1 Hz, 6.1 Hz, 1F), −144.9(1F).

### (B) Preparation of Polymer F1

The interior of an autoclave (internal capacity: 230 cm³, made of stainless steel) was replaced with nitrogen, followed by sufficient deaeration. Under reduced pressure, 68.67 g of compound (ml2), 40.02 g of compound (m21), 45.03 g of compound (2-1) as a solvent, 68.2 mg of compound (3-1) as a radical initiator, and 6.96 g of methanol were charged, and the autoclave was deaerated to the vapor pressure:

CClF₂CF₂CHClF (2-1)

(CH₃)₂CHOC(═O)OOC(═O)OCH(CH₃)₂ (3-1)

The internal temperature was raised to 40° C., tetrafluoroethylene (hereinafter referred to as TFE) was introduced to the autoclave, and the pressure was adjusted to 0.42 MPaG (gauge pressure). Polymerization was carried out for 6.5 hours while the temperature and the pressure were maintained constant. Then, the autoclave was cooled to terminate the polymerization, and the gas in the system was purged.

The reaction liquid was diluted with compound (2-1), and compound (2-2) was added to coagulate the polymer, followed by filtration:

CH₃CCl₂F (2-2)

The polymer was stirred in compound (2-1), and compound (2-2) was added to re-coagulate the polymer, followed by filtration. Such recoagulation was repeated twice. The polymer was dried under reduced pressure at 80° C. overnight, to obtain polymer F1 which is a copolymer of TFE, compound (m12) and compound (m21). The yield was 15.1 g. An ion exchange membrane was formed in the same manner as in Example 1, and the ion exchange capacity and the softening temperature were measured, whereupon results as shown in Table 3 were obtained.

### (C) Preparation of Polymer H1

With respect to the obtained polymer F1, a fluorine gas diluted to 20% with a nitrogen gas was introduced to 0.3 MPaG, and the polymer F1 was maintained at 180° C. for 4 hours. Then, hot pressing was carried out to obtain a membrane having a thickness of about 50 μm. For hydrolysis, the membrane was immersed in a solution of KOH in water and dimethyl sulfoxide as solvents (KOH/water/dimethyl sulfoxide=15/55/30 mass ratio) and then immersed in hydrochloric acid for conversion to an acid form and then washed with ultrapure water to obtain polymer H1.

### (D) Preparation of Electrolyte Membrane E1

To polymer H1, a mixed dispersion medium of ethanol and water (ethanol/water=50/50 mass ratio) was added to adjust the solid content concentration to 30 mass %, followed by stirring at 120° C. for 8 hours in an autoclave. Water was further added to adjust the solid content concentration to 24 mass% to obtain liquid composition S1 having polymer H1 dispersed in a dispersion medium. The composition of the dispersion medium was ethanol/water=40/60 (mass ratio).

To the solvent mixture comprising 40 g of ethanol and 60 g of water, 1 g of the liquid composition and 5 g of cerium oxide were added, and ultrasonic waves were applied for 10 minutes to uniformly disperse cerium oxide. The obtained dispersion liquid was added to liquid composition S1, followed by stirring at room temperature for 4 hours. Here, the mixture was adjusted so that the content of cerium oxide contained in the polymer would be finally 4.8 wt %. The above obtained mixed liquid was applied to an ETFE sheet by a die coater, dried at 80° C. for 30 minutes and further annealed at 180° C. for 30 minutes to obtain electrolyte membrane E1 having a thickness of 25 μm.

### (E) Durability Test of Electrolyte Membrane

A membrane/electrode assembly is obtained in the same manner as in Example 1 and assembled into a cell for power generation, and hydrogen (utilization ratio: 50%) and an air (utilization ratio: 50%) as gases humidified at a dew point of 73° C. are supplied to the cell. The cell was maintained at a cell temperature of 120° C. in an open circuit state where no electric current flows. The discharged gas was bubbled to a 0.1 N potassium hydroxide aqueous solution, and the discharged hydrogen fluoride was collected and quantitatively analyzed as fluorine ions by means of ion chromatography to calculate the discharged fluorine ion concentration. The fluorine ion discharge rate after 300 hours is shown in Table 3.

### EXAMPLES 14 TO 16

In the same manner as in Example 13 except that the content of cerium oxide was as identified in Table 3, an electrolyte membrane was formed and a membrane/electrode assembly was obtained. Example 16 is a Comparative Example in which no cerium oxide was contained. The fluorine ion discharge rate in durability test was as shown in Table 3.

TABLE 1

| | Ion exchange | Softening | |
|---|---|---|---|
| | capacity | temperature | Cerium ion |
| | (meq/g dry resin) | (° C.) | content (%) |
| Ex. 1 | 1.13 | 130 | 10 |
| Ex. 2 | 1.25 | 108 | 9 |
| Ex. 3 | 1.00 | 115 | 10 |
| Ex. 4 | 1.23 | 98 | 11 |
| Ex. 5 | 1.10 | 98 | 9 |
| Ex. 6 | 1.05 | 127 | 9 |
| Ex. 12 | 1.20 | 71 | — |

TABLE 2

| | | Time until the |
|---|---|---|
| | Initial output | voltage decreased |
| | voltage (V) | to 0.5 V |
| Ex. 1 | 0.72 | ⊚ |
| Ex. 2 | 0.73 | ◯ |
| Ex. 3 | 0.74 | ◯ |
| Ex. 4 | 0.71 | ◯ |
| Ex. 5 | 0.70 | ◯ |
| Ex. 6 | 0.73 | ⊚ |
| Ex. 7 | 0.77 | X |
| Ex. 8 | 0.75 | X |
| Ex. 9 | 0.76 | X |
| Ex. 10 | 0.76 | X |
| Ex. 11 | 0.77 | X |
| Ex. 12 | 0.77 | X |

TABLE 3

| | Ion | | | Fluorine |
|---|---|---|---|---|
| | exchange | | | ion |
| | capacity | Softening | Cerium ion | discharge |
| | (meq/g dry | temperature | content | rate |
| | resin) | (° C.) | (%) | (μg/day · cm²) |
| Ex. 13 | 1.56 | 92 | 4.8 | 0.3 |
| Ex. 14 | ↓ | ↓ | 3.2 | 1.3 |
| Ex. 15 | ↓ | ↓ | 1.6 | 1.5 |
| Ex. 16 | ↓ | ↓ | — | 41 |

The electrolyte membrane of the present invention has a high softening temperature and is very excellent in durability against hydrogen peroxide and peroxide radicals formed by power generation of a fuel cell. Accordingly, a polymer electrolyte fuel cell provided with a membrane/electrode assembly having the electrolyte membrane of the present invention has durability over a long period of time either in power generation under low humidification and in power generation under high humidification, at high operation temperature.

The entire disclosure of Japanese Patent Application No. 2005-121028 filed on Apr. 19, 2005 including specification, claims and summary is incorporated herein by reference in its entirety.

What is claimed is:

1. An electrolyte membrane for a polymer electrolyte fuel cell, which comprises an ion exchange membrane made of a fluoropolymer having a softening temperature of at least 90° C. and having acidic groups, and contains cerium atoms.

2. The electrolyte membrane for a polymer electrolyte fuel cell according to claim 1, wherein the cerium atoms are contained as cerium ions.

3. The electrolyte membrane for a polymer electrolyte fuel cell according to claim 1, wherein the cerium atoms are contained as cerium oxide.

4. The electrolyte membrane for a polymer electrolyte fuel cell according to claim 1, wherein the acidic groups are sulfonic acid groups.

5. The electrolyte membrane for a polymer electrolyte fuel cell according to claim 4, wherein the cerium atoms are contained as cerium ions in an amount of from 0.3 to 20 mol % of —SO₃⁻ groups contained in the ion exchange membrane.

6. The electrolyte membrane for a polymer electrolyte fuel cell according to claim 4, wherein the cerium atoms are contained as cerium oxide in an amount of from 0.3 to 80% (mass ratio) of the entire mass of the electrolyte membrane.

7. The electrolyte membrane for a polymer electrolyte fuel cell according to claim 4, wherein the fluoropolymer having acidic groups is a perfluorocarbon polymer having sulfonic acid groups (which may contain an etheric oxygen atom).

8. The electrolyte membrane for a polymer electrolyte fuel cell according to claim 7, wherein the cerium atoms are contained as cerium ions in an amount of from 0.3 to 20 mol % of —SO₃⁻ groups contained in the ion exchange membrane.

9. The electrolyte membrane for a polymer electrolyte fuel cell according to claim 7, wherein the cerium atoms are contained as cerium oxide in an amount of from 0.3 to 80% (mass ratio) of the entire mass of the electrolyte membrane.

10. A membrane/electrode assembly for a polymer electrolyte fuel cell comprising an anode and a cathode each having a catalyst layer containing a catalyst, and an electrolyte membrane disposed between the anode and the cathode, wherein the electrolyte membrane comprises an ion exchange membrane made of a fluoropolymer having a softening temperature of at least 90° C. and having acidic groups, and contains cerium atoms.

11. The membrane/electrode assembly for a polymer electrolyte fuel cell according to claim 10, wherein the cerium atoms are contained as cerium ions.

12. The membrane/electrode assembly for a polymer electrolyte fuel cell according to claim 10, wherein the cerium atoms are contained as cerium oxide.

13. The membrane/electrode assembly for a polymer electrolyte fuel cell according to claim 10, wherein the acidic groups are sulfonic acid groups.

14. The membrane/electrode assembly for a polymer electrolyte fuel cell according to claim 13, wherein the fluoropolymer having acidic groups is a perfluorocarbon polymer having sulfonic acid groups (which may contain an etheric oxygen atom).

15. The membrane/electrode assembly for a polymer electrolyte fuel cell according to claim 14, wherein the cerium atoms are contained as cerium ions in an amount of from 0.3 to 20 mol % of —SO₃⁻ groups contained in the ion exchange membrane.

16. The membrane/electrode assembly for a polymer electrolyte fuel cell according to claim 14, wherein the cerium atoms are contained as cerium oxide in an amount of from 0.3 to 80% (mass ratio) of the entire mass of the electrolyte membrane.

17. A method of operating a polymer electrolyte fuel cell provided with a membrane/electrode assembly comprising an anode and a cathode each having a catalyst layer containing a catalyst, and an electrolyte membrane disposed between the anode and the cathode, the electrolyte membrane comprising an ion exchange membrane made of a fluoropolymer having a softening temperature of at least 90° C. and having acidic groups, and containing cerium atoms, which comprises power generation by supplying a hydrogen gas to the anode side and oxygen or an air to the cathode side at a temperature of at least 90° C.
